(19) United States
(12) Patent Application Publication
(10) Pub. No.: US 2007/0220852 A1
(43) Pub. Date: Sep. 27, 2007

(54) High Capacity Filter Medium

(75) Inventors: Norman Lifshutz, Nashua, NH (US); Douglas Klauber, Nashua, NH (US); Richard E. Gahan, Wrentham, MA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: Hollingsworth and Vose Company, East Walpole, MA (US)

(21) Appl. No.: 11/277,575

(22) Filed: Mar. 27, 2006

(51) Int. Cl. B01D 46/00

(52) U.S. Cl. 55/486

(57) ABSTRACT

Various high performance, high efficiency, long service interval air filter media that are cost effective and easy to manufacture are provided. The filter media of the present invention can have at least two layers comprising blends of binder and non-binder fibers that are thermally bonded to one another and set to caliper in a high velocity forced draft oven. The layers can also be subsequently resin saturated, dried, and optionally cured. The resulting media can be characterized as having a gradient in properties such as fiber composition, fiber diameter, solidity, basis weight, and saturant content.

### FIELD OF THE INVENTION

The present invention relates to air filters, and more particularly to a high capacity filter medium.

### BACKGROUND OF THE INVENTION

The removal of air borne particulate contaminants from the air is a concern to everyone. Gas phase particulate filtration has traditionally been accomplished by methods that utilize woven or nonwoven fabrics or webs. These materials are pleated into flat panels or round cartridges through which the air is passed. The performance of such a system is characterized by the initial efficiency of removal or capture of the particulate as a function of particle size, the initial resistance of the system to air or gas flow as a function of gas flow rate or face velocity, and the way both of these factors change as the filter element loads with the particulate contaminant. The effective life of the element is the time or total amount of particulate contaminant loading required for the resistance of the system to reach some specified limit.

These pleatable or moldable materials can range from high efficiency surface filter media to filter media that have a lower efficiency but a higher capacity. One approach for forming pleatable or moldable media has been to use short cut fibers in an airlaid process to form webs, however these media often have poor strength characteristics. Another approach has been to use long cut fibers in a carded process, but these fibers often have a low production rate. Pleatable or moldable media can also be made from synthetic fibers, using bicomponent fibers for thermal or point bonding, however this tends to produce a sheet that is often too soft and has poor pleatability or moldability. While resin or latex saturants can be incorporated into the media to provide stiffness for pleatability or embossability, this can require a high add on, and often tends to produce a sheet that is too dense, with excessive resistance, particularly after molding or embossing.

Accordingly, there remains a need to provide an improved air filter, and more particularly an improved high capacity filter medium with acceptable pleatability and moldability for processing.

### SUMMARY OF THE INVENTION

The present invention provides various high loft and low solidity filter media. In one aspect, the filter media of the present invention includes an upstream layer having a blend of at least about 10 percent by weight binder fibers and a balance of non-binder fibers with a diameter in the range of about 10-50 microns, and a downstream layer having a blend of at least about 25 percent by weight binder fibers and a balance of non-binder fibers. The activation temperature of the binder fibers in both the upstream and downstream layers is lower than the melting temperature of the non-binder fibers. The media can also include at least about 10 dry weight percent of a polymeric saturant.

The media can be constructed to have any number of layers between the upstream-most and the downstream-most layer. In one embodiment, the filter media can include a middle layer having a blend of at least about 10 percent by weight binder fibers and a balance of non-binder fibers with a diameter in the range of about 10-25 microns, wherein the activation temperature of the binder fibers is lower than the melting temperature of the non-binder fibers.

The layers of the filter media can be thermally bonded such that the filter media exhibits a gradient in at least one of the following properties: ratio of binder to non-binder fibers, fiber diameter, solidity, basis weight, and amount of added saturant. In one embodiment, the fibers of the upstream layer can be coarser than the fibers of the downstream layer, for example the fibers of the upstream layer can have a diameter in the range of about 10-50 microns, or more preferably in the range of about 25-50 microns, and the fibers of the downstream layer can have a diameter of about 10 microns. In another embodiment, the upstream-most layer of the media can be lighter than the downstream-most layer, and the upstream layer can have a solidity in the range of about 1-4 percent, the middle layer can have a solidity in the range of about 3-6 percent, and the downstream layer can have a solidity in the range of about 6-12 percent. Additionally, and/or alternatively, the upstream layer can have a basis weight in the range of about 25-50 g/m², the middle layer can have a basis weight in the range of about 25-75 g/m², and the downstream layer can have a basis weight in the range of about 75-200 g/m².

A variety of binder fibers can be used to form the filter media of the present invention. In one embodiment, the binder fibers can be bicomponent fibers having a core and a sheath, wherein the activation temperature of the sheath is lower than the melting temperature of the core. Exemplary core/sheath binder fibers include those having a polyester core/copolyester sheath, a polyester core/polyethylene sheath, a polyester core/polypropylene sheath, a polypropylene core/polyethylene sheath, and combinations thereof. In another embodiment, the binder fibers can be monocomponent fibers such as ethylene vinyl alcohol, polyvinyl alcohol, polyvinyl chloride, polyvinyl acetate, and copolymers and combinations thereof.

A variety of non-binder fibers can also be used to form the media of the present invention, and in one embodiment the non-binder fibers can be about 100 percent synthetic fibers. Alternatively, the non-binder fibers can include at least about 50 percent synthetic fibers and a balance of non-synthetic fibers selected from the group consisting of glass fibers, cellulose pulp fibers, and combinations thereof.

Any saturant effective for facilitating formability and pleatability of the media can be used, and exemplary saturants can include a polymer selected from the group consisting of phenolic resins, melamine resins, urea resins, epoxy resins, polyacrylate esters, polystyrene/acrylates, polyvinyl chlorides, polyethylene/vinyl chlorides, polyvinyl acetates, polyvinyl alcohols, and combinations and copolymers thereof, present in an aqueous or organic solvent.

In another aspect, a filter media is provided that includes an upstream layer having a blend of binder fibers and non-binder fibers, wherein an activation temperature of the binder fibers is lower than a melting temperature of the non-binder fibers, a downstream layer having a blend of binder fibers and non-binder fibers, wherein the activation temperature of the binder fibers is lower than the melting temperature of the non-binder fibers, and a saturant. The properties of the media can also exhibit a gradient, and in one embodiment, the upstream layer can be lighter than the downstream layer. By way of non-limiting example, the upstream layer can have a solidity that is less than about 4 percent, and the downstream layer can have a solidity that is greater than that of the upstream layer. The filter media can also include a middle layer located between the upstream layer and the downstream layer and having a blend of binder fibers and non-binder fibers, wherein the activation temperature of the binder fibers is lower than the melting temperature of the non-binder fibers. The middle layer can also have a solidity that is greater than that of the upstream layer and less than that of the downstream layer. The filter media can have a variety of other configurations, and in one embodiment the filter media can be pleatable.

In another aspect, a filter media is provided that includes an upstream layer having a blend of at least about 10 percent by weight binder fibers and a balance of non-binder fibers, a middle layer having a blend of at least about 10 percent by weight binder fibers and a balance of non-binder fibers, and a downstream layer having a blend of at least about 25 percent by weight binder fibers and a balance of non-binder fibers. The filter media can be pleatable and have a Gurley stiffness of at least about 1000 gms.

In another aspect, an induction air filter is provided that includes a housing having an opening therethrough that is adapted to extend transversely to a direction of an air stream. The filter can also include a pleatable filter media disposed within the housing. Generally, the media can include an upstream layer having an airlaid blend of bicomponent binder fibers and non-binder fibers with a diameter in the range of about 10-50 microns, and a downstream layer having an airlaid blend of bicomponent binder fibers and non-binder fibers with a diameter of less than about 10 microns. The air induction filter can be further adapted for use in an internal combustion engine that can have a useful life of at least 100,000 miles.

The media can be adapted to exhibit a gradient in a variety of properties, and in one embodiment, the media can be adapted to exhibit a gradient in fiber diameter. For example, the upstream layer can include an airlaid blend of at least about 10 percent by weight bicomponent binder fibers and a balance of non-binder fibers having a diameter in the range of about 25-50 microns, and a downstream layer having an airlaid blend of at least about 25 percent by weight binder fibers and a balance of non-binder fibers having a diameter of less than about 10 microns. An activation temperature of the binder fibers of both the upstream and downstream layers is lower than the melting temperature of the non-binder fibers. The media can also include a middle layer disposed in the housing between the upstream layer and the downstream layer and having an airlaid blend of at least about 10 percent by weight binder fibers and a balance of non-binder fibers with a diameter in the range of about 10-25 microns, wherein the activation temperature of the binder fibers is lower than the melting temperature of the non-binder fibers.

In addition to exhibiting a gradient in fiber diameter, the layers of the media can also optionally be adapted to exhibit a gradient in solidity and basis weight. In one embodiment, the upstream layer can have a solidity in the range of about 1-3 percent, the middle layer can have a solidity in the range of about 3-6 percent, and the downstream layer can have a solidity in the range of about 6-10 percent. In another embodiment, the upstream layer can have a basis weight in the range of about 25-50 g/m², the middle layer can have a basis weight in the range of about 25-75 g/m², and the downstream layer can have a basis weight in the range of about 75-200 g/m².

### BRIEF DESCRIPTION OF THE DRAWINGS

FIG. 1 is a schematic illustrating one embodiment of an air induction filter.

### DETAILED DESCRIPTION OF THE INVENTION

Certain exemplary embodiments will now be described to provide an overall understanding of the principles of the structure, function, manufacture, and use of the devices and methods disclosed herein. Those skilled in the art will understand that the devices and methods specifically described herein are non-limiting exemplary embodiments and that the scope of the present invention is defined solely by the claims. The features described in connection with one exemplary embodiment may be combined with the features of other embodiments. Such modifications and variations are intended to be included within the scope of the present invention.

In one aspect, the present invention provides various high performance, high efficiency, long service interval air filter media that are cost effective and easy to manufacture. The filter media of the present invention can have at least two layers, each including blends of binder fibers and non-binder fibers. The layers can be thermally bonded to one another and set to caliper in a high velocity forced draft oven. The layers can also be subsequently resin saturated, dried, and optionally cured. The resulting media can be characterized as having a gradient in at least one, and optionally all, of the following properties: binder and non-binder fibers composition, fiber diameter, solidity, basis weight, and saturant content. For example, in one embodiment, the media can have a lightweight, lofty, coarse-fibered, lightly bonded and lightly saturated sheet upstream, and a heavier, denser, fine-fibered, heavily bonded and heavily saturated sheet downstream. This gradient is particularly advantageous in that it provides a more uniform distribution of dust throughout the entire media, and it also allows the media to be formed using about 100 percent by weight synthetic binder and non-binder fibers, as opposed to a combination of synthetic and non-synthetic binder and non-binder fibers, as will be discussed in more detail below. The filter media disclosed herein can be used in a variety of applications, and can be suitable for high capacity depth filter media having high initial filtration efficiency. Exemplary filter applications for the media described herein include use in internal combustion engine filters, industrial engine filters, heavy duty air filters, ASHRAE filtering applications, home furnace filters, vacuum cleaners, EDM applications, passenger cars, and machining filtration applications.

In one embodiment, a filter media can include upstream and downstream layers, each having binder fibers and non-binder fibers that are thermally bonded to one another, and a saturant. The upstream layer can have a variety of configurations, and can be adapted to provide capacity to the media. In an exemplary embodiment, the upstream layer can include a blend of about 10 percent by weight binder fibers, more preferably about 10-50 percent by weight binder fibers, and most preferably about 10-40 percent by weight binder fibers, and a balance of non-binder fibers. The amount of non-binder fibers can vary, however by way of non-limiting example, the upstream layer can have less than about 90 percent by weight non-binder fibers, more preferably about 50-90 percent by weight non-binder fibers, and most preferably about 60-90 percent by weight non-binder fibers.

The downstream layer can be adapted to contribute stiffness to the media and to allow for fine filtration. In an exemplary embodiment, the downstream layer can include a blend of at least about 35 percent by weight binder fibers, and more preferably about 25-60 percent by weight binder fibers, and a balance of non-binder fibers. The amount of non-binder fibers can also vary, however in an exemplary embodiment the non-binder fibers can be present at about 40-70 percent by weight. As explained below, the filter media can be constructed to have any number of layers disposed between the upstream-most layer and the downstream-most layer.

The filter media can also have a property gradient from the upstream-most layer to the downstream-most layer. A variety of the media's properties can exhibit this gradient, such as the ratio of binder fibers to non-binder fibers present in the layer, the fiber diameter, the basis weight, the solidity, and the amount of saturant. For example, as discussed above, the amount of binder fiber per layer increases from the upstream layers to the downstream layers such that the downstream layer can provide stiffness to the media.

The diameter of the non-binder fibers can decrease from the upstream-most to the downstream-most layer, such that the finest fibers are located in the downstream-most layer. In one embodiment, the diameter of the non-binder fibers of the upstream layer can be in the range of about 10-50 microns, and more preferably about 25-50 microns, and the diameter of the non-binder fibers of the downstream layer can be less than about 10 microns. This allows the coarser particles to be trapped in the upstream layer, preventing early saturation of the bottom layer.

Additionally, or alternatively to the gradient of the diameter of the fibers, the solidity and/or the basis weight of the upstream-most and the downstream-most layers can also exhibit a gradient. In one embodiment, the upstream layer can be lighter and/or loftier than the downstream layer. That is, the upstream layer can have a solidity (e.g., the solid volume fraction of fibers in the web) and a basis weight that is less than that of the downstream layer. For example, and while the solidity and basis weight can vary depending upon the intended application for the media, when the media is used in industrial engine filters, the solidity of the upstream layer can be less than or equal to about 4 percent, more preferably in the range of about 1-4 percent, and most preferably about 1-3 percent, and the solidity of the downstream layer can be in the range of about 6-12 percent, more preferably about 6-10 percent. The basis weight of the upstream layer can be in the range of about 25-50 g/m², and more preferably about 40 g/m², and the basis weight of the downstream layer can be in the range of about 75-200 g/m², and more preferably about 120 g/m².

The filter media can also have a gradient with respect to the amount of saturant in the upstream and downstream layers. For example, in one embodiment the amount of saturant can be uniformly distributed between the upstream and downstream layers. Alternatively, the downstream layer can have a greater amount of saturant than the upstream layer such that the upstream layer is unbonded to facilitate particulate capture. For example, the downstream layer can have a resin concentration in the range of about 10-90 percent by weight, and more preferably in the range of about 10-40 percent by weight, while the upstream layer can have a resin concentration in the range of about 0-20 percent by weight, and more preferably in the range of about 0-15 percent by weight.

While one exemplary embodiment discusses a filter media having two layers, the filter media can have any number of other layers located between the upstream layer and the downstream layer and having a blend of binder and non-binder fibers. For example, and in one embodiment, the filter media can include a middle layer having a blend of at least about 10 percent by weight binder fibers, and more preferably about 10-40 percent by weight binder fibers, and a balance of non-binder fibers. While the middle layer can have various amounts of non-binder fibers, in an exemplary embodiment the middle layer can have about 60-90 percent by weight non-binder fibers.

To maintain the gradient between the upstream and downstream layers, the fibers of the middle layer can be finer than those of the downstream layer, yet coarser than those of the upstream layer. For example, in an exemplary embodiment the diameter of the non-binder fibers can be in the range of about 10-25 microns. The solidity and basis weight of the middle layer can be greater than that of the upstream layer but less than that of the downstream layer. While the solidity and basis weight of the middle layer can vary depending upon the intended application for the media, when the media is used in industrial engine filters, the solidity of the middle layer is in the range of about 3-6 percent, and the basis weight is in the range of about 25-75 g/m², and more preferably about 40 g/m². The amount of saturant in the middle layer can be in the range of about 10-90 percent by weight, and more preferably in the range of about 10-30 percent by weight.

In other embodiments, such as where the media is used for internal combustion engine filters, ASHRAE filtering applications, and home furnace applications, the diameter of the fibers can decrease from the upstream to the downstream layers, and the weight of the layers can increase from the upstream to the downstream layers, as shown in Table 1.

TABLE 1
Properties of Filter Media By Application

| Application | Fiber Layer | Fiber Diameter | | Solidity | Basis Weight | |
|---|---|---|---|---|---|---|
| Internal | Upstream | 10 to 50 | microns | 1 to 4% | 25 to 50 | g/m² |
| Combustion | Middle | 10 to 25 | microns | 3 to 6% | 25 to 75 | g/m² |
| Engine Filters | Downstream | Less than 10 | microns | 6 to 12% | 75 to 200 | g/m² |
| ASHRAE | Upstream | 25 to 50 | microns | 1 to 4% | 25 to 50 | g/m² |
| Filtering | Middle | 10 to 50 | microns | 1 to 4% | 25 to 50 | g/m² |
| Applications | Downstream | <10 to 25 | microns | 6 to 12% | 25 to 50 | g/m² |
| Home Furnace | Upstream | 25 to 50 | microns | 1 to 4% | 25 to 50 | g/m² |
| Filters | Middle | 10 to 50 | microns | 1 to 4% | 25 to 50 | g/m² |
| | Downstream | <10 to 25 | microns | 6 to 12% | 25 to 50 | g/m² |

The media can also exhibit a variety of other properties and performance data, and these can vary depending on the application of the media. However, when the media is used in industrial engine filter applications, the filter media can have a Gurley stiffness of about 1000 gms. The industrial engine filter media can also have a high efficiency, such as an efficiency greater than about 70 percent, and a longer useful life, that is, the amount of dust that the media can hold before the pressure drop across the element exceeds a preset limit. For example, the filter element can last in excess of about 36 months, and have a useful life of about 100,000 miles.

Where the media can be used in applications such as internal combustion engine filters, heavy duty air filters, ASHRAE filters, and home furnace filters, other property performance data of the media can be as shown in Table 2.

TABLE 2
Additional Properties/Performance Data of Filter Media By Application

| Application | Gurley Stiffness | Efficiency | Useful Life |
|---|---|---|---|
| Internal Combustion | >2000 mg | >70% | 100,000 miles |
| Engine Filters | | | |
| Heavy Duty Air | >2000 mg | >95% | 100,000 miles |
| Filters | | | |
| ASHRAE Filtering | >900 mg | 35 to >95%, | 1″ H₂O |
| Applications | | 3 to 10 micron | Pressure Drop |
| | | particles | |
| Home Furnace | >900 mg | 50 to >85%, | 3 months |
| Filters | | 3 to 10 micron | |
| | | particles | |

A person skilled in the art will appreciate that a variety of types of binder and non-binder fibers can be used to form the media of the present invention. The binder fibers can be formed from any material that is effective to facilitate thermal bonding between the layers, and can have an activation temperature that is lower than the melting temperature of the non-binder fibers. The binder fibers can be monocomponent or any one of a number of bicomponent binder fibers. In one embodiment, the binder fibers can be bicomponent fibers, and each component can have a different melting temperature. For example, the binder fibers can include a core and a sheath where the activation temperature of the sheath is lower than the melting temperature of the core. This allows the sheath to melt prior to the core, such that the sheath binds to other fibers in the layer, while the core maintains its structural integrity. This is particularly advantageous in that it creates a more cohesive layer for trapping filtrate. The core/sheath binder fibers can be concentric or non-concentric, and exemplary core/sheath binder fibers can be made of a polyester core/copolyester sheath, a polyester core/polyethylene sheath, a polyester core/polypropylene sheath, a polypropylene core/polyethylene sheath, and combinations thereof. Other exemplary bicomponent binder fibers can include split fiber fibers, side-by-side fibers, and/or “island in the sea” fibers. In another embodiment, the binder fibers can be monocomponent, and exemplary monocomponent binder fibers include water soluble materials such as ethylene vinyl alcohols, polyvinyl alcohols, polyvinyl chloride, polyvinyl acetate, and combinations and copolymers thereof. The monocomponent binder fibers can be activated upon the application of steam and/or some other form of warm moisture, and the moisture and heat cause them to bind to other fibers in the layer. Exemplary bicomponent binder fibers can include Trevira Types 254, 255, and 256; Invista Cellbond® Type 255; Fiber Innovations Types 201, 202, 215, and 252; and ES Fibervisions AL-Adhesion-C ESC 806A.

The non-binder fibers can be synthetic and/or non-synthetic, and in an exemplary embodiment the non-binder fibers can be about 100 percent synthetic. In general, synthetic fibers are preferred over non-synthetic fibers for resistance to moisture, heat, long-term aging, and microbiological degradation. Exemplary synthetic non-binder fibers can include polyesters, acrylics, polyolefins, nylons, rayons, and combinations thereof. Alternatively, the non-binder fibers used to form the media can include at least about 50 percent synthetic fibers and a balance of non-synthetic fibers such as glass fibers, glass wool fibers, cellulose pulp fibers, such as wood pulp fibers, and combinations thereof. Exemplary synthetic non-binder fibers can include Trevira Type 290 and Wellman Fortrel® Types 204, 289 and 510.

The binder fibers and the non-binder fibers of the present invention can also have a variety of lengths, however in an exemplary embodiment the fibers can have a length in the range of about 6-12 mm.

A variety of saturants can be used with the media of the present invention to facilitate the formability and pleatability of the layers at a temperature that is less than the melting temperature of the fibers. Exemplary saturants can include phenolic resins, melamine resins, urea resins, epoxy resins, polyacrylate esters, polystyrene/acrylates, polyvinyl chlorides, polyethylene/vinyl chlorides, polyvinyl acetates, polyvinyl alcohols, and combinations and copolymers thereof that are present in an aqueous or organic solvent. While the media can have any amount of saturant, and this amount can vary depending upon the intended application for the media, in one embodiment where the media is used for internal combustion engine air intake filters, the media can include at least about 10 dry weight percent of saturant, more preferably about 10-30 dry weight percent of saturant.

The layers of the media can be formed using a wetlaid, carded, or airlaid technique, however generally an airlaid technique can be used. This is particularly advantageous in that it contributes economical manufacturing while retaining the filtration efficiency properties of the material. The airlaid technique also causes the media to have a high loft structure, resulting in more open area for holding dust. Once the layers of the media are formed by an airlaid technique, the binder fibers can be activated to effect bonding of the fibers. As noted above, a variety of techniques can be used to activate the binder fibers. For example, if bicomponent binder fibers having a core and sheath are used, the binder fibers can be activated upon the application of heat. If monocomponent binder fibers are used, the binder fibers can be activated upon the application of steam and/or some other form of warm moisture. Following bonding of the layers, such as thermal bonding to set the solidity gradient, a saturant can be applied to the material, and the material dried as well as optionally cured and/or pleated.

The following non-limiting examples are provided to further illustrate media formations according to the present invention.

### EXAMPLE 1

A filter media was made on a Marketing Technology Services Greyline Airlaid Pilot line using a DanWeb drum airlaid system. Three forming heads were used to lay down three different fiber blends. All synthetic fibers were 6 mm long for processing in the DanWeb system. Top layer was 40 g/m² and was made of a blend of 75% Wellman 15 denier polyester staple (or non-binder) fiber and 25% of Trevira 1.5 denier Type 255 binder fiber, which has a polyester core and polyethylene sheath with a melting point of 130° C. The middle layer was 40 g/m² and was made with a blend of 75% Wellman 6 denier polyester staple fiber and 25% Trevira 1.5 denier Type 255 binder fiber. The bottom layer was 100 g/m² and was made with a blend of 50% Wellman 0.8 denier polyester staple fiber and 50% Trevira 1.5 denier Type 255 binder fiber. After forming the layers, the entire web was thermally bonded by passing the web through an air-through oven at 140° C. The web was then foam saturated to a dry saturant content of 26.0% with Dur-O-Set C310 polyvinyl acetate latex saturant. The Gurley stiffness before saturation was 880 mg and after saturation was 4900 mg.

### EXAMPLE 2

A second filter media was made similar to Example 1 except a single fiber blend was run through the three forming heads. A total web weight of 180 g/m² was made with 15% Wellman 15 denier polyester staple fiber, 15% Wellman 6 denier polyester staple fiber, 30% Wellman 0.8 denier staple fiber, and 40% Trevira 1.5 denier Type 255 binder fiber. The web was bonded in an air-through oven under same conditions as Example 1 and foam saturated to a dry saturant content of 23.8% with Dur-O-Set C310 polyvinyl acetate latex saturant. The Gurley stiffness before saturation was 400 mg and after saturation was 2800 mg.

### EXAMPLE 3

A third filter media was made with the same three layers of fibers and the same equipment as Example 1 except the bottom layer was heavier at 120 g/m². This bonded web was saturated by the same method as Sample 1 to a dry saturant content of 28.1%. The Gurley stiffness before saturation was 1240 mg and after saturation was 7700 mg.

### EXAMPLE 4

A fourth filter media was made with a similar construction as Example 3 except the bottom layer fiber composition included wood pulp. The wood pulp used was Rayonier Ray-Floc and was fed into the forming head with the other fibers after being opened in a hammermill. The fiber composition of the bottom layer was 25% Wellman 0.8 denier polyester staple fiber, 50% Rayonier Ray-Floc fluff pulpa and 25% Trevira 1.5 denier Type 255 binder fiber. After oven bonding, the sample was saturated the same as the previous samples to a dry saturant content of 28.4%. The Gurley stiffness before saturation was 960 mg and after saturation was 6700 mg.

The media formed in Examples 1-4 were all tested on a Palas MFP 2000 flat sheet filter test stand, using PTI Fine Test Dust as specified in ISO 12103-A2 at 800 mg/m³ dust concentration in air, at an air flow rate of 120 L/m on an area of 100 cm² for a face velocity 20 cm/s and a dust feed rate of 96 mg/m. The particle capture efficiency as a function of the particle size was measured using a PCS-2010 aerosol spectrometer, and the particle counts were integrated to provide a total efficiency. Both efficiency and pressure drop were measured as a function of total dust loading, to an endpoint resistance of 2500 Pa to determine dust holding capacity. The resulting air permeability, basis weight, initial and final efficiency, and dust holding capacity of the media of Examples 1-4 are shown in Table 3 below.

TABLE 3
Flat Sheet Test Results for Examples 1-4

| | | | | | Dust |
|---|---|---|---|---|---|
| | Air | Basis | Initial | Final | Holding |
| | Permeability | Weight | Efficiency | Efficiency | Capacity |
| Media | (cfm) | (g/m²) | (%) | (%) | (g/m²) |
| Example 1 | 99 | 223 | 84.5 | 99.9 | 603 |
| Example 2 | 128 | 220 | 88.8 | 99.4 | 278 |
| Example 3 | 86 | 256 | 90.0 | 99.92 | 603 |
| Example 4 | 82 | 254 | 82.2 | 99.96 | 458 |

Additionally, six inch wide coils of the media of Examples 1-4 were rotary pleated using a 360° F. preheat temperature into pleat packs with a 1.0 inch pleat height. Simple cylindrical elements were fabricated with 51 pleats, and radially distributed around a perforated 3.75 inch diameter center tube using plastisol endcaps. These elements were tested on an element filtration test stand according to SAE Test Method J726 using PTI Fine Test Dust as defined by ISO 12103 A2, at a concentration of 0.2833 g/ft³, with a flow rate of 192 CFM for a face velocity of 20 cm/sec or 39.37 ft/m. An initial efficiency was determined gravimetrically, and the elements were then run to a pressure drop increase of 12.4 inches of water to determine capacity, at which point the final or life average efficiency was determined gravimetrically. The resulting initial and final element efficiency and element dust holding capacity of the media of Examples 1-4 are shown in Table 4 below.

TABLE 4
Round Element Test Results for Examples 1-4

| | Initial Efficiency | Final Efficiency | Dust Holding Capacity |
|---|---|---|---|
| Media | (%) | (%) | (g/m²) |
| Example 1 | 99.6 | 99.7 | 344 |
| Example 2 | 99.3 | 99.5 | 177 |
| Example 3 | 98.7 | 99.5 | 334 |
| Example 4 | 98.7 | 99.6 | 372 |

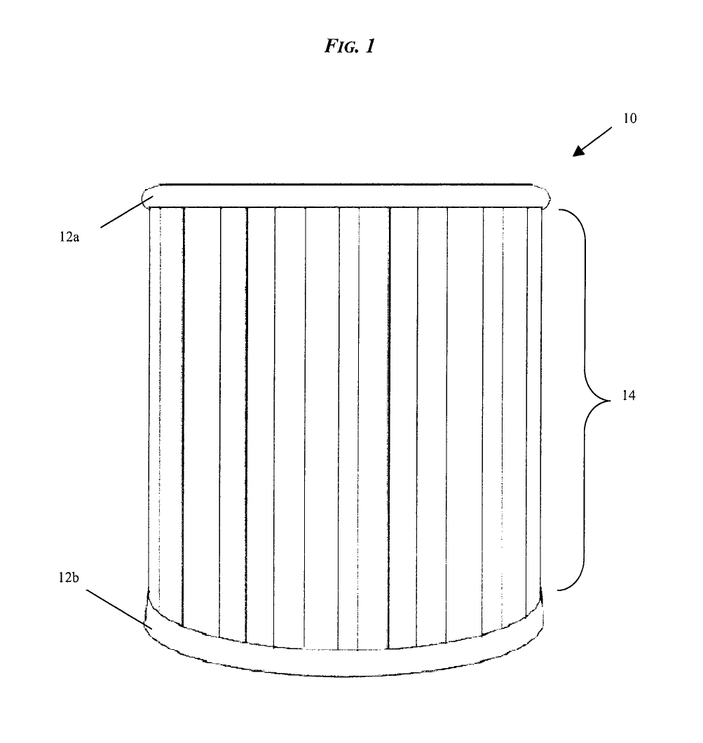

As noted above, the filter media of the present invention can have a variety of uses. In one embodiment, for example and as shown in FIG. 1, the media 14 can be used in an induction air filter 10. The induction air filter 10 can have any configuration known in the art, however generally the filter has a housing having proximal and distal ends 12a, 12b with an opening (not shown) that extends therethrough and is transverse to the flow of an airstream. A filter media 14 having any number of layers is disposed within the air filter 10.

One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

What is claimed is:

1. A filter media, comprising:
an upstream layer comprising a blend of at least about 10 percent by weight binder fibers and a balance of non-binder fibers having a diameter in the range of about 10-50 microns, wherein an activation temperature of the binder fibers is lower than a melting temperature of the non-binder fibers;
a downstream layer comprising a blend of at least about 25 percent by weight binder fibers and a balance of non-binder fibers, wherein the activation temperature of the binder fibers is lower than the melting temperature of the non-binder fibers; and
at least about 10 dry weight percent of a polymeric saturant,
wherein the layers of the filter media are thermally bonded such that the filter media exhibits a solidity gradient that increases from the upstream layer to the downstream layer.

2. The filter media of claim 1, wherein the non-binder fibers of the downstream layer have a diameter of less than about 10 microns.

3. The filter media of claim 1, wherein the media has a Gurley stiffness of at least about 1000 gms.

4. The filter media of claim 1, wherein the non-binder fibers of the upstream layer have a diameter in the range of about 25-50 microns, and
the filter media further comprises a middle layer comprising a blend of at least about 10 percent by weight binder fibers and a balance of non-binder fibers having a diameter in the range of about 10-25 microns, wherein the activation temperature of the binder fibers is lower than the melting temperature of the non-binder fibers.

5. The filter media of claim 4, wherein the binder fibers are bicomponent fibers having a core and a sheath, wherein the activation temperature of the sheath is lower than the melting temperature of the core.

6. The filter media of claim 5, wherein the binder fibers are selected from the group consisting of a polyester core/copolyester sheath, a polyester core/polyethylene sheath, a polyester core/polypropylene sheath, a polypropylene core/polyethylene sheath, and combinations thereof.

7. The filter media of claim 4, wherein the binder fibers are monocomponent.

8. The filter media of claim 7, wherein the monocomponent binder fibers are selected from the group consisting of ethylene vinyl alcohol, polyvinyl alcohol, polyvinyl chloride, polyvinyl acetate, and copolymers and combinations thereof.

9. The filter media of claim 4, wherein the upstream layer has a solidity in the range of about 1-4 percent.

10. The filter media of claim 4, wherein the middle layer has a solidity in the range of about 3-6 percent.

11. The filter media of claim 4, wherein the downstream layer has a solidity in the range of about 6-12 percent.

12. The filter media of claim 4, wherein each layer is an airlaid blend of fibers.

13. The filter media of claim 4, wherein the upstream layer has a basis weight in the range of about 25-50 g/m².

14. The filter media of claim 4, wherein the middle layer has a basis weight in the range of about 25-75 g/m².

15. The filter media of claim 4, wherein the downstream layer has a basis weight in the range of about 75-200 g/m².

16. The filter media of claim 4, wherein the non-binder fibers are selected from the group consisting of synthetic fibers, glass fibers, cellulose pulp fibers, and combinations thereof.

17. The filter media of claim 16, wherein the synthetic fibers are selected from the group consisting of polyesters, acrylics, polyolefins, nylons, rayons, and combinations thereof.

18. The filter media of claim 1, wherein the polymeric saturant includes a polymer selected from the group consisting of phenolic resins, melamine resins, urea resins, epoxy resins, polyacrylate esters, polystyrene/acrylates, polyvinyl chlorides, polyethylene/vinyl chlorides, polyvinyl acetates, polyvinyl alcohols, and combinations and copolymers thereof present in an aqueous or organic solvent.

19. The filter media of claim 1, further comprising an amount of saturant in the range of about 10 percent to 30 percent by weight.

20. The filter media of claim 1, further comprising a plurality of layers disposed between the upstream layer and the downstream layer and comprising a blend of bicomponent binder fibers and non-binder fibers.

21. The filter media of claim 1, wherein the filter media is pleatable.

22. A filter media, comprising:
an upstream layer comprising a blend of binder fibers and non-binder fibers, wherein an activation temperature of the binder fibers is lower than a melting temperature of the non-binder fibers, the upstream layer having a solidity of less than about 4 percent;
a downstream layer comprising a blend of binder fibers and non-binder fibers, wherein the activation temperature of the binder fibers is lower than the melting temperature of the non-binder fibers, the downstream layer having a solidity greater than that of the upstream layer; and
a saturant,
wherein the filter media is pleatable.

23. The filter media of claim 22, further comprising a middle layer located between the upstream layer and the downstream layer and comprising a blend of binder fibers and non-binder fibers, wherein the activation temperature of the binder fibers is lower than the melting temperature of the non-binder fibers, the middle layer having a solidity that is greater than that of the upstream layer and less than that of the downstream layer.

24. The filter media of claim 23, wherein the upstream layer comprises at least about 10 percent by weight binder fibers and a balance of non-binder fibers, the middle layer comprises at least about 10 percent by weight binder fibers and a balance of non-binder fibers, and the downstream layer comprises at least about 25 percent by weight binder fibers and a balance of non-binder fibers.

25. The filter media of claim 23, wherein the upstream layer has a non-binder fiber diameter in the range of about 25-50 microns, the middle layer has a non-binder fiber diameter in the range of about 10-25 microns, and the downstream layer has a non-binder fiber diameter of less than about 10 microns.

26. The filter media of claim 23, wherein the upstream layer has a basis weight in the range of about 25-50 g/m², the middle layer has a basis weight in the range of about 25-75 g/m², and the downstream layer has a basis weight in the range of about 75-200 g/m².

27. The filter media of claim 23, wherein each layer is an airlaid blend of fibers.

28. The filter media of claim 23, wherein the binder fibers are bicomponent fibers selected from the group consisting of a polyester core/copolyester sheath, a polyester core/polyethylene sheath, a polyester core/polypropylene sheath, a polypropylene core/polyethylene sheath, and combinations thereof.

29. The filter media of claim 23, wherein the binder fibers are monocomponent fibers selected from the group consisting of ethylene vinyl alcohol, polyvinyl alcohol, polyvinyl chloride, polyvinyl acetate, and copolymers and combinations thereof.

30. The filter media of claim 23, wherein the non-binder fibers are selected from the group consisting of synthetic fibers, glass fibers, cellulose pulp fibers, and combinations thereof.

31. The filter media of claim 23, wherein the saturant includes a polymer selected from the group consisting of phenolic resins, melamine resins, urea resins, epoxy resins, polyacrylic esters, polystyrene/acrylates, polyvinyl chlorides, polyethylene/vinyl chlorides, polyvinyl acetates, polyvinyl alcohols, and combinations and copolymers thereof present in an aqueous or organic solvent.

32. A filter media, comprising:
an upstream layer comprising a blend of at least about 10 percent by weight binder fibers and a balance of non-binder fibers;
a middle layer comprising a blend of at least about 10 percent by weight binder fibers and a balance of non-binder fibers; and
a downstream layer comprising a blend of at least about 25 percent by weight binder fibers and a balance of non-binder fibers,
wherein the filter media is pleatable and has a Gurley stiffness of at least about 1000 gms.

33. The filter media of claim 32, wherein the upstream layer has a non-binder fiber diameter in the range of about 25-50 microns, the middle layer has a non-binder fiber diameter in the range of about 10-25 microns, and the downstream layer has a non-binder fiber diameter of less than about 10 microns.

34. The filter media of claim 32, wherein the upstream layer has a solidity in the range of about 1-3 percent, the middle layer has a solidity in the range of about 3-6 percent, and the downstream layer has a solidity in the range of about 6-10 percent.

35. The filter media of claim 32, wherein the upstream layer has a basis weight in the range of about 25-50 g/m², the middle layer has a basis weight in the range of about 25-75 g/m², and the downstream layer has a basis weight in the range of about 75-200 g/m².

36. The filter media of claim 32, wherein each layer is an airlaid blend of fibers.

37. The filter media of claim 32, wherein the binder fibers are selected from the group consisting of a polyester core/copolyester sheath, a polyester core/polyethylene sheath, a polyester core/polypropylene sheath, a polypropylene core/polyethylene sheath, and combinations thereof.

38. The filter media of claim 32, wherein the binder fibers are selected from the group consisting of ethylene vinyl alcohol, polyvinyl alcohol, and copolymers and combinations thereof.

39. The filter media of claim 32, wherein the non-binder fibers are selected from the group consisting of synthetic fibers, glass fibers, cellulose pulp fibers, and combinations thereof.

40. The filter media of claim 39, wherein the synthetic fibers are selected from the group consisting of polyesters, acrylics, polyolefins, nylons, rayons, and combinations thereof.

41. The filter media of claim 32, further comprising a polymeric saturant having a polymer selected from the group consisting of phenolic resins, melamine resins, urea resins, epoxy resins, polyacrylic esters, polystyrene/acrylates, polyvinyl chlorides, polyethylene/vinyl chlorides, polyvinyl acetates, polyvinyl alcohols, and combinations and copolymers thereof present in an aqueous or organic solvent.

42. An induction air filter, comprising:
a housing having an opening therethrough adapted to extend transversely to a direction of an air stream; and
a pleatable filter media disposed within the housing that includes:
an upstream layer comprising an airlaid blend of bicomponent binder fibers and non-binder fibers having a diameter in the range of about 10-50 microns;
a downstream layer comprising an airlaid blend of bicomponent binder fibers and non-binder fibers having a diameter of less than about 10 microns,
wherein the filter has a useful life of at least 100,000 miles.

43. The filter of claim 42, wherein the filter is adapted for use in an internal combustion engine.

44. The filter of claim 42, wherein the upstream layer comprises an airlaid blend of at least about 10 percent by weight bicomponent binder fibers and a balance of non-binder fibers having a diameter in the range of about 25-50 microns, wherein an activation temperature of the binder fibers is lower than a melting temperature of the non-binder fibers;
the downstream layer comprises an airlaid blend of at least about 25 percent by weight binder fibers and a balance of non-binder fibers having a diameter of less than about 10 microns, wherein the activation temperature of the binder fibers is lower than the melting temperature of the non-binder fibers; and
the media further comprises a middle layer disposed in the housing between the upstream layer and the downstream layer and comprising an airlaid blend of at least about 10 percent by weight binder fibers and a balance of non-binder fibers having a diameter in the range of about 10-25 microns, wherein the activation temperature of the binder fibers is lower than the melting temperature of the non-binder fibers.

45. The filter of claim 44, wherein the upstream layer has a basis weight in the range of about 25-50 g/m², the middle layer has a basis weight in the range of about 25-50 g/m², and the downstream layer has a basis weight in the range of about 75-125 g/m².

46. The filter of claim 42, wherein the filter media further comprises a saturant having a polymer selected from the group consisting of phenolic resins, melamine resins, urea resins, epoxy resins, polyacrylic esters, polystyrene/acrylates, polyvinyl chlorides, polyethylene/vinyl chlorides, polyvinyl acetates, polyvinyl alcohols, and combinations and copolymers thereof present in an aqueous or organic solution.

47. The filter media of claim 44, wherein the upstream layer has a solidity in the range of about 1-3 percent, the middle layer has a solidity in the range of about 3-6 percent, and the downstream layer has a solidity in the range of about 6-10 percent.
